(19) United States
(12) Patent Application Publication
(10) Pub. No.: US 2018/0022478 A1
(43) Pub. Date: Jan. 25, 2018

(54) SPACE RADIATION ENVIRONMENT EMULATOR

(71) Applicant: Jeff Chancellor, League City, TX (US)

(72) Inventor: Jeff Chancellor, League City, TX (US)

(73) Assignee: Jeff Chancellor, League City, TX (US)

(21) Appl. No.: 15/499,679

(22) Filed: Apr. 27, 2017

Related U.S. Application Data
(60) Provisional application No. 62/328,231, filed on Apr. 27, 2016.

(51) Int. Cl. B64G 7/00

(52) U.S. Cl. CPC B64G 7/00

(57) ABSTRACT

A moderator block. The moderator block includes one or more layers of a hydrogen-rich material. A plurality of voids disposed in the one or more hydrogen-rich layers. The plurality of voids is configured to generate a final particle field such that a linear energy transfer (LET) spectrum of the final particle field corresponds to a measured LET.

### CROSS-REFERENCE TO RELATED APPLICATIONS

This application claims the benefit of U.S. Provisional Application Ser. No. 62/328,231 filed Apr. 27, 2016 and titled “Space Radiation Environment Emulator”. The provisional application is incorporated by reference herein as if reproduced in full below.

### BACKGROUND

Radiobiology studies on the effects of galactic cosmic ray radiation utilize mono-energetic beams, where the projected doses for exploration missions are given using highly-acute exposures. This methodology does not replicate the multi-ion species and energies found in the space radiation environment, nor does it reflect the low dose-rate found in interplanetary space. In radiation biology studies as well as in the assessment of health risk to astronaut crews, the differences in the biological effectiveness of different ions is primarily attributed to differences in the linear energy transfer of the radiation spectrum. Thus, there is a need in the art for systems and methods to emulate the space radiation environment, and linear energy transfer of the radiation spectrum in for the evaluation, in a ground-based environment, of radiological response in biological systems as well as electronics and materials to the radiation that may be encountered in spaceflight and in space exploration.

### BRIEF DESCRIPTION OF THE DRAWINGS

For a detailed description of various embodiments, reference will now be made to the accompanying drawings in which:

FIGS. 1 and 1A show a side elevation and front elevation view, respectively, of a moderator block in accordance with at least some embodiments;

FIGS. 2 and 2A show a side elevation and front elevation, respectively, view of a moderator block in accordance with at least some embodiments;

FIG. 3 shows a graph of a linear energy transfer spectrum in accordance with at least some embodiments;

FIG. 4 shows a graph of a linear energy transfer spectrum in accordance with at least some embodiments;

FIG. 5 shows a graph of a linear energy transfer spectrum in accordance with at least some embodiments; and

FIG. 6 shows a flow chart of a method in accordance with at least some embodiments.

### NOTATION AND NOMENCLATURE

Certain terms are used throughout the following description and claims to refer to particular system components. As one skilled in the art will appreciate, different companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection or through an indirect connection via other devices and connections.

“About” as used herein in conjunction with a numerical value shall mean the recited numerical value as may be determined accounting for generally accepted variation in measurement, manufacture and the like in the relevant industry.

### DETAILED DESCRIPTION

The following discussion is directed to various embodiments. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Recent studies have demonstrated that the biological response to space radiation is unique to a non-homogeneous, multi-energetic dose distribution similar to the interplanetary space environment. It is therefore easy to conclude that previous radiobiological models and experiments utilizing mono-energetic beams may not have fully characterized the biological responses or described the impact of space radiation on the health of vital tissues and organ systems. There are many variables that contribute to uncertainties in the outcomes of space radiobiology studies. These include, first, the utilization of animal models with differing responses and sensitivity to radiation, second, epidemiology studies of human populations exposed to whole body irradiation at high doses and high a dose-rates limited to scenarios not found during space exploration missions, and third, simulating the spectrum of energies, ion species, doses, and dose rates found in the space radiation environment is a non-trivial endeavor.

Currently, radiobiology studies on the effects of galactic cosmic ray (GCR) radiation utilize mono-energetic beams (e.g., Li, C, O, Si, Fe, etc.) at heavy-ion accelerators where the projected dose for an entire exploration class mission is given to animals using highly-acute, single ion exposures. This does not reflect the low dose rate found in interplanetary space. Nor does it accurately replicate the multi-ion species and energies found in the GCR radiation environment that can cause multi-organ dose toxicity, inhibiting cell regrowth and tissue repair mechanisms.

The simultaneous reproduction of both the dose rate and the ions found in the GCR spectrum is unlikely because of limits in current accelerator technologies. A reasonable goal would be to simulate the linear energy transfer (LET) distribution of the GCR environment. Although the LET is not uniquely related to biological response, it is an important metric that is utilized to determine radiation tissue damage. It remains the focus of many biological investigations and serves as the basis of radiation protection and risk assessment. In radiation biology studies, the differences in the relative biological effectiveness (RBE) of different ions are, in part, attributed to differences in the LET of the radiation. Our model leverages available technologies to provide an enhancement to current ground-based analogs of the space radiation environment by reproducing the measured intravehicular (IVA) LET spectrum.

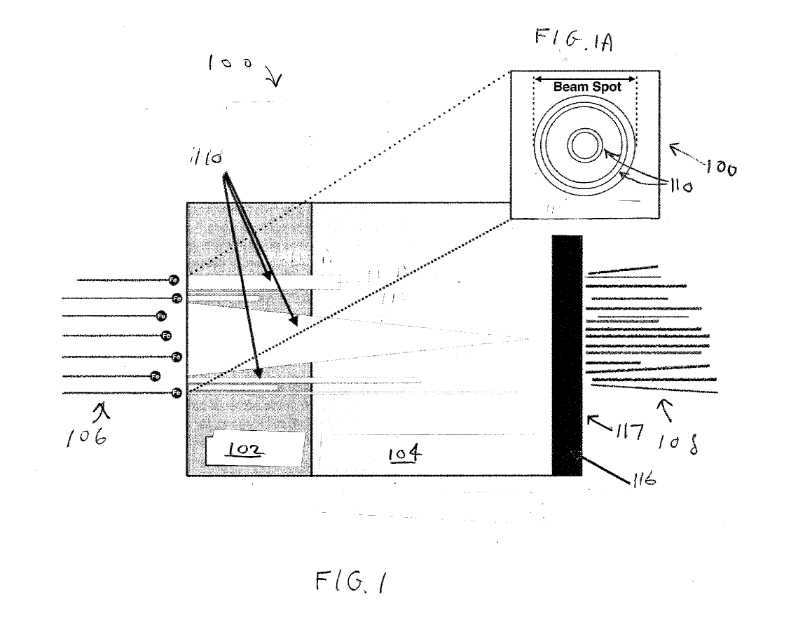

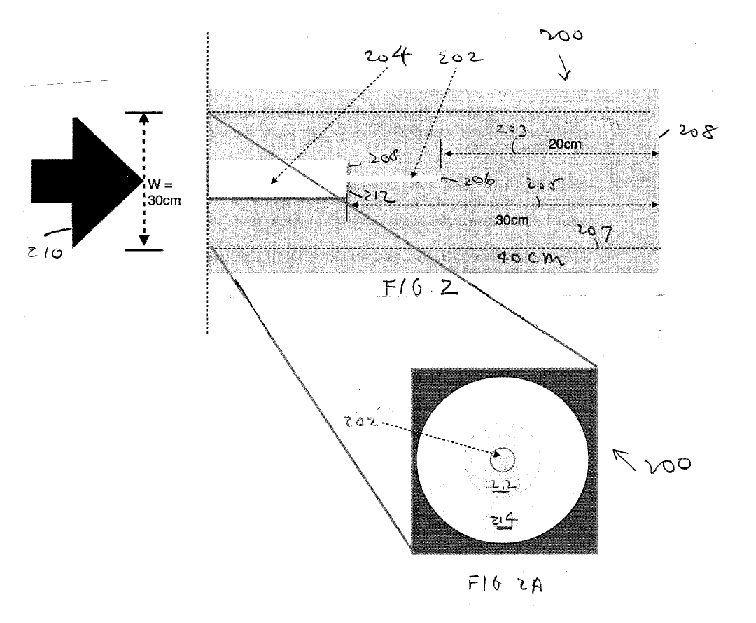

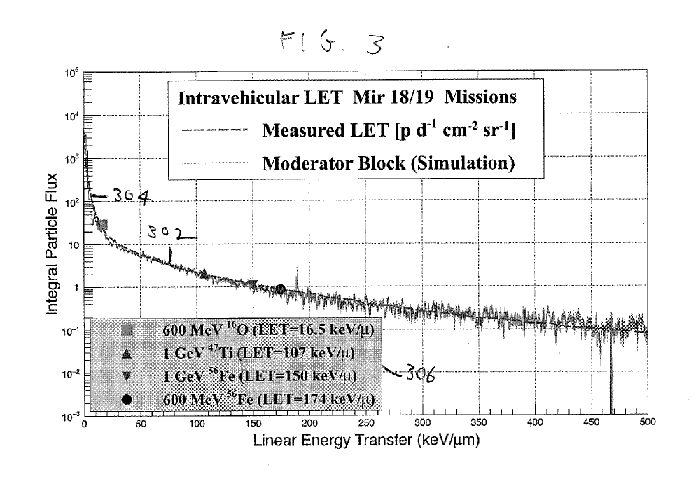

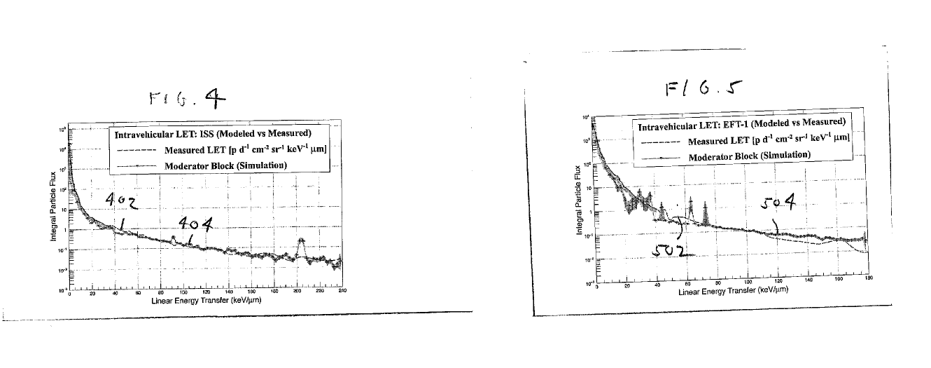

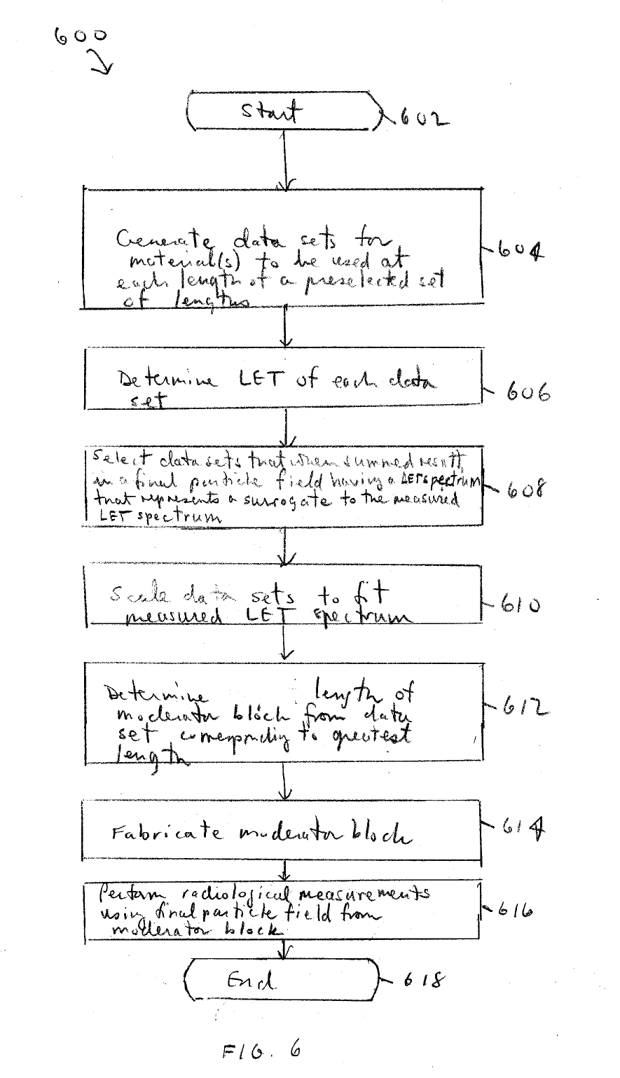

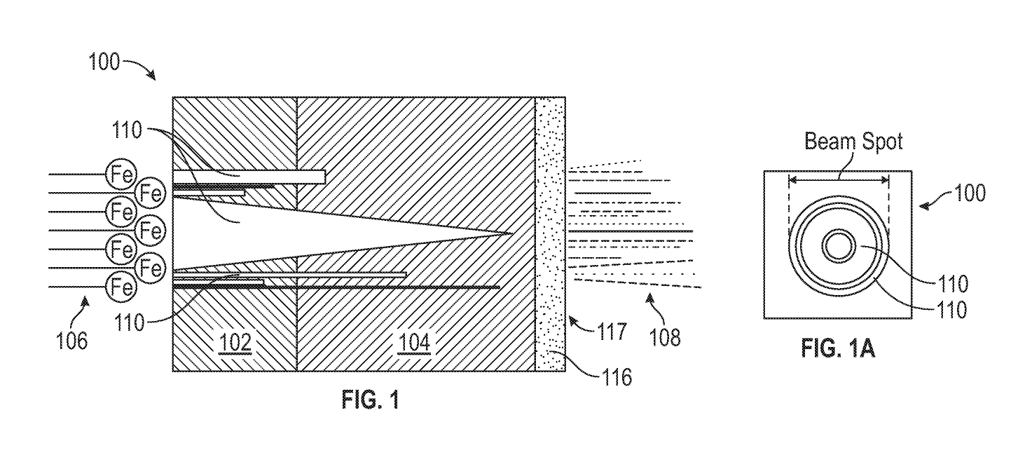

Turning to FIGS. 1 and 1A, there are shown side and front elevation views of a moderator block 100 in accordance with at least some embodiments. Moderator block 100 is composed of two materials 102 and 104, which may be, for example, proton rich materials such as polyethylene, high-density polyethylene (HDPE) or LEXAN. However, other materials may be used in accordance with the principles of the disclosure. IN some embodiments materials 102 and 104 may be the same composition and in other embodiments materials 102 and 104 may be different compositions. In operation a beam of energetic ions impinges on moderator block 100. Energetic ion beam 106 may comprise 1000 mega-electron-volt (1000 MeV or 1 Gev) iron ions (e.g. ⁵⁶Fe). Moderator block 100 may also include a high-Z scattering layer 116. In at least some embodiments, The high-Z scattering layer can be made from materials such as Lead (⁷⁸Pb) or Tungsten (⁷⁴W). However, any suitable high-Z material may be used. The high-Z scattering layer can provide Coulomb scattering to help make the resulting field homogenous across the exiting surface 117. It would be appreciated by those skilled in the art having the benefit of the disclosure that the high-Z scattering layer may also be placed closer to surface 106 to attenuate fission neutron production. A final field, F(i,E), of particles 108 is emitted from moderator block 100. These may be generated within moderator block 100 by nuclear reactions and as spallation products.

A moderator block 100 may be designed so that the final field, F(i,E) closely simulates the IVA LET spectrum measured on previous spaceflights, F(i,E)=G\f[i,E(i)], Where E(i) is the kinetic energy of ion i, f(i,E) the initial field impinging the target moderator block, and G is a function that represents the geometry and intrinsic material properties affecting charged particles traversing the moderator. This target moderator block can be placed in front of, e.g., a 1000 MeV Iron (⁵⁶Fe) particle beam, as described above, and nuclear spallation processes will create modest amounts of the desired fragments resulting in a complex mixed field of particle nuclei (hereinafter, simply “final particle field”) with different atomic numbers Z in the range 0<Z<=26 and LETs <=500 keV/micron. Modifications to the internal geometry and chemical composition of the materials in the target moderator block allow for shaping the emulated IVA LET F(i,E) to specific spectra (e.g., external GCR field, Mars spectrum, etc.). For example, plurality of cuts or voids 110 are disposed within moderator block 100 allow for shaping the final particle field IVA LET.

The calculations were performed using the Monte Carlo particle transport simulation PHITS in order to model particles traversing through thick absorbers and to develop a close approximation of the desired LET spectrum. PHITS features an event generator mode that produces a fully correlated transport for all particles with energies up to 200 GeV. It calculates the average energy loss and stopping power by using the charge density of the material and the momentum of the primary particle by tracking the fluctuations of energy loss and angular deviation. PHITS utilizes the SPAR code for simulating ionization processes of the charge particles and the average stopping power, dE/dx. The primary beam 106, e.g. 1 GeV ⁵⁶Fe is accelerated from the left, propagated through the moderator block and emerging along with progeny fragments generated during spallation reactions with the block materials. The field continues to the right where a scoring plane is located 1 m from the moderator block face. Particle species, energy, and directional cosines are recorded for analysis and LET calculations. The LET values (in tissue) are then calculated using the stopping power formula.

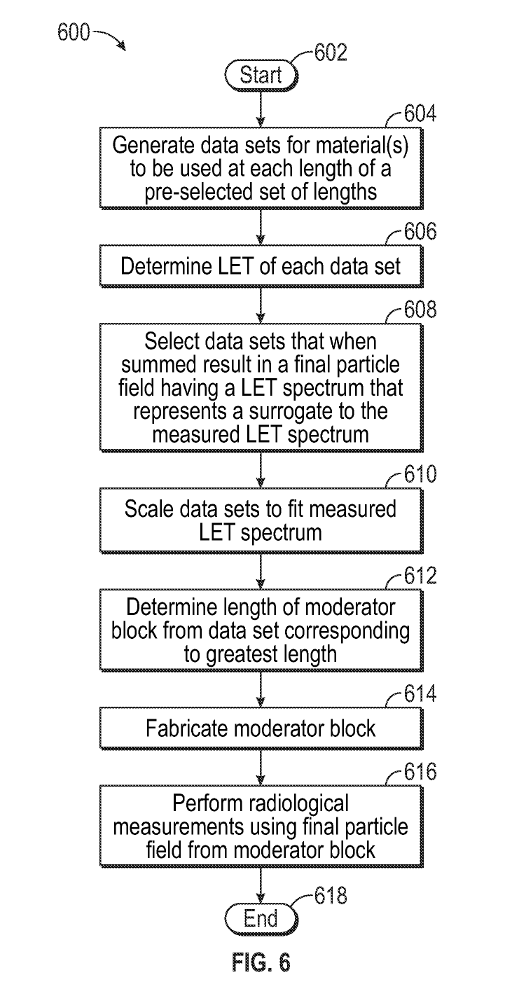

The length of travel through a medium can not only positively (or negatively) enhance the number of desired lower-Z ions generated and the energy loss of the primary and secondary ions generated, but it can also affect nuclei yields by depleting the number of high-Z ions still needed. In order to generate the GCR spectrum, the moderator geometry and thickness need to balance the effects of energy loss and fragmentation. This is done by designing the moderator block 100 geometry so that it replicates the attenuation function G for the desired field F(i,E) via F(i,E)=G f[i,E(i)]. The attenuation G describes the various channels of the moderator block as shown in FIG. 6 and is a function of the geometry and the intrinsic properties of each material utilized in the moderator design. Each channel or “cut” or “void” 110 represents a separate path the primary ions can travel through the block. The diameter, length and material of each cut are chosen to induce specific spallation and energy loss events of the primary ion. This provides a method to selectively induce specific fragmentation and energy losses that result in the emerging final particle field having the desired distribution of emerging ions and energies.

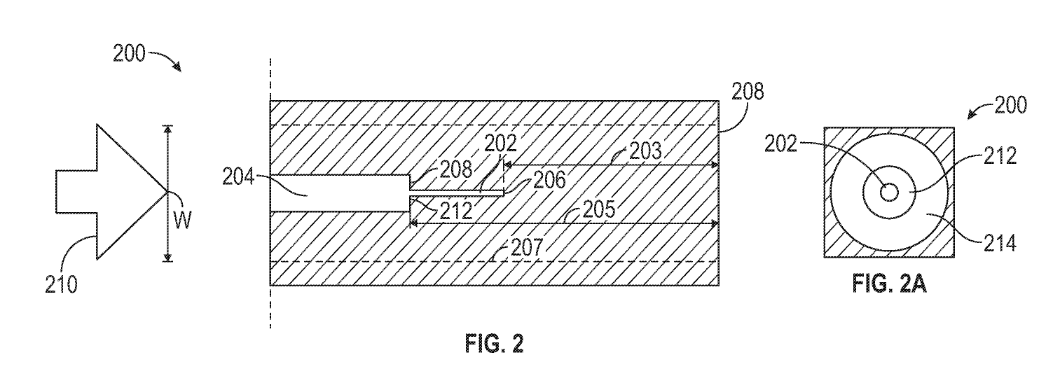

Referring now to FIGS. 2 and 2A FIGS. 2 and 2A show side and front elevation views, respectively, of a moderator block 200 in accordance with at least some embodiment. Moderator block may have a length 207 which may be 40 centimeters (cm) in at least some embodiments. Moderator block 200 includes two voids 202 and 204. An end 206 of void 202 is located 20 cm from end 208 of moderator block 200 opposite energetic ion beam 210. Ion beam 210 may, for example, have a diameter of 30 cm. Thus a length of material 203 remains between end 206 and end 208 of the moderator block. Length 203 may be 20 cm in at least some embodiments. An end 212 of void 208 is located a length 205 from end 208 of moderator block 200. Length 205 may be 30 cm in at least some embodiments. A cross-sectional area of void 202 may be about 0.70615 cm², and an area of annular region 212 may be about 141.2304 cm² and an area of annular region 214 may be about 549.92176 cm² in at least some embodiments. Lengths 203, 205, 207 and the areas of void 202 and the annular regions 212, 214 will be described further in conjunction with FIG. 6.

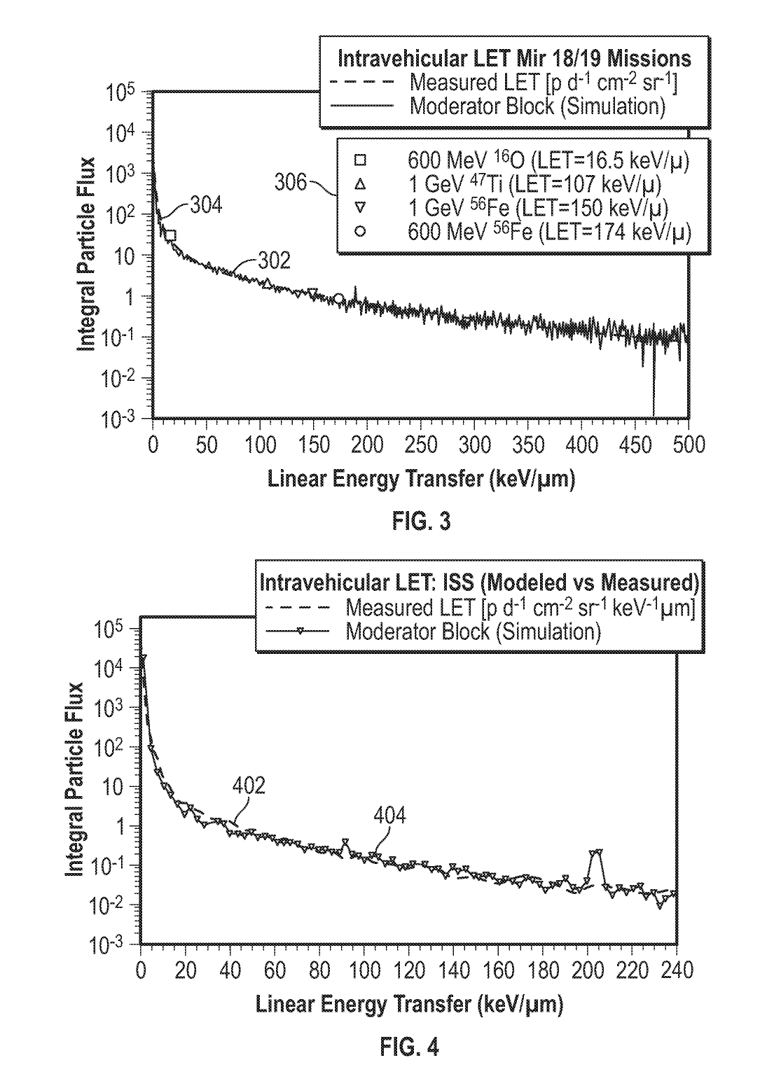

Moderator block 200 may be used to emulate the IVA LET spectrum as measured during the MIR 18 and Mir 19 missions. The Mir Space Station had an orbital inclination and flight altitude of 51.6 degrees and approximately 200 nautical miles (approximately 370 km). Beginning in March of 1995, NASA astronauts flew several long-duration missions on the Mir Space Station, returning to earth via the Space Shuttle. Badhwar et. al. measured the integral LET spectrum that was directly attributed to GCR ions and their spallation progeny using tissue equivalent proportional counters (TEPC) and plastic nuclear track detectors located at six different areas of the vehicle. Contributions from neutrons and non GCR particles (e.g., Van Allen Belt ions) were not considered in order to closely replicate their measured results. The results seen in FIG. 3 demonstrate that the distribution of LET obtained from the beam-line simulation fits extremely well with the prediction for particles having a LET between 20 keV/micron and 200 keV/micron and with a reasonable fit for LET up to 500 keV/micron. FIG. 3 shows a plot of the IVA LET spectrum for the MIR 18 and Mir 19 missions. The solid line 302 shows the LET spectrum as determined by Monte Carlo particle simulations for moderator block 200. The simulations are performed using the Monte Carlo particle transport simulation software PHITS, in order to model particles traversing through thick absorbers and develop a close approximation to the desired LET spectrum. The correct fluence of particles required can be determined using data from satellite measurements, intravehicular measurements during space missions, or from models of the GCR spectrum. PHITS has been previously compared to experimental cross section data using similar energies and materials. The output is appropriately scaled to closely match the average daily LET rate measured. The dashed line 304 shows the measured LET spectrum. Inset 306 shows LET of four single-ion exposures (290 MeV ¹⁴C, 600 Mev ¹⁶O, 1 GeV ⁴⁷Ti, 1 GeV ⁵⁶Fe, and 600 Mev ⁵⁶Fe). These highlight the lack of breadth of energies in related art radiological damage studies. Note that the simulated target moderator block reproduces the spectrum over approximately six orders of magnitude.

FIG. 4 shows the measured IVA LET spectrum from the ISS (dashed line 402) and simulation results of a moderator block design in accordance with at least some embodiments (solid line 404). LET measurements were taken using the Timepix hybrid pixel detector. Note that our moderator block technology is also able to match the IVA spectrum of charged particles measured on board the ISS. NASA's ISS was launched into orbit in 1998 and is still flying with an orbital inclination of 51.6 degrees and an altitude of 249 miles (approximately 400 km). The measurement of the LET spectrum includes all charged particles (electrons, pions, heavy charged particles, etc.), excludes neutrons.

The contribution of particles with low LET (<=40 keV/micron) falls off much more slowly than what was seen in the Mir 18/19 measurements. This results in a moderator block with a much more complex geometry, including layers with thicknesses much greater than previously anticipated (>50 cm) that could generate the low-Z, high-energy particles needed to shape this portion of the LET distribution. The resulting spectrum closely matches the measured energies to a high degree of accuracy for continuous LET values of up to 240 keV/micron over approximately seven orders of magnitude. The sharp peaks in the modeled LET spectra seen at 90 keV/micron and 205 keV/micron result from an overabundance of low-energy protons (E<=2 MeV) generated in the thicker portion of the moderator block. These results indicate that modifications to the internal block geometry and material composition can successfully fit dose spectra for space vehicles with vastly different structure and shielding capabilities (e.g., the Mir Space Station versus the much larger International Space Station with thicker shielding).

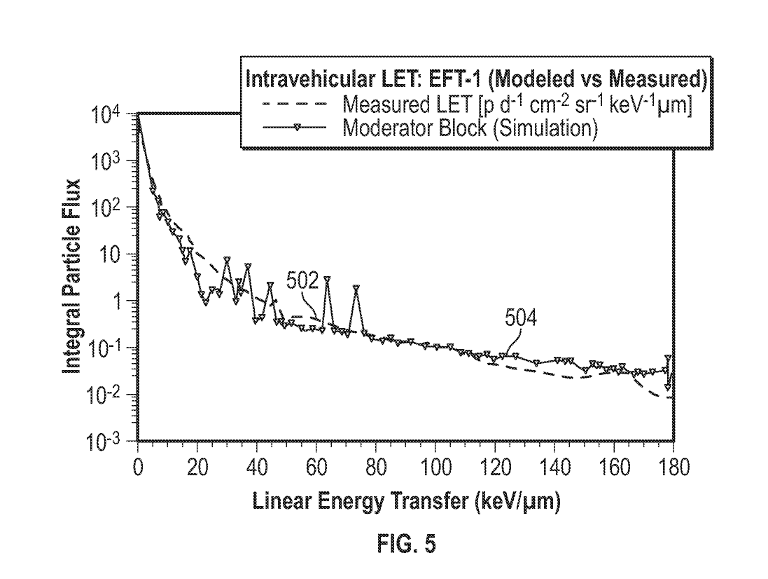

FIG. 5 shows a measured LET spectrum for the Exploration Flight Test (EFT-1) (dashed line 502) along long with the results of a simulation of a moderator block designed in accordance with at least some embodiments (solid line 504). EFT-1 launched in Dec. 5, 2014, it flew for 4 hours, 24 minutes. Although a much shorter duration (approximately four hours), the EFT-1 data is unique because of a high apogee on the second orbit that included traversal through the radiation dense Van Allen Belts and briefly into the interplanetary radiation environment. Timepix based radiation detectors were operational shortly after liftoff and collected data for the duration of the mission. Non-charged particles were not measured and therefore the design methodology did not include thermal and fast spallation neutrons. Our results fit reasonably well with the flight measurements, however with visible fluctuations in the 30-80 keV/micron range with several sharp peaks at ˜65 keV/micron and ˜73 keV/micron. This weakly corresponds to a smaller fluctuation found from 30-50 keV/micron in the measured data. It is not yet clear whether these are indicators of the true nature of the measured LET spectrum, or are simple statistical fluctuations resulting from the smaller measurement period of the EFT-1 flight (approximately 4 h). Moderator layers made of polyethylene as thick as 100 cm are required to produce this LET spectrum. The sharp peaks at ˜65 keV/micron and ˜73 keV/micron in our results are due to an overabundance of ions with charge Z<=6 in these 90 cm and thicker layers.

FIG. 6 shows a flow chart of a method 600 in accordance with at least some embodiments. Method 600 starts at block 602. In block 604, data sets at each length of a preselected set of lengths of material are generated for the material(s) to be used for the moderator block. For example a set of material lengths may include lengths of about 5 cm to about 100 cm in steps of 5 cm. These values are exemplary and other sets of values may be used. The data sets may be generated for a particular primary beam, which may be based on a particular experimental beam source. Each data set may be generated by a Monte Carlo simulation as previously described, and may comprise a distribution of particle species having various energies. In block 606, the LET of each of the data sets is determined. In block 608, data sets are selected that when summed result in a final particle field having a LET spectrum that represents a surrogate to the measured LET spectrum (such as a LET measured during the flight of a spacecraft, as described above) having a degree of fidelity the investigation of radiological effects in a preselected material system, biological system, or electronic or other physical system. Stated otherwise, the LET spectrum of the final particle field represents the measured LET spectrum such that the investigated radiological effects in the preselected material system, biological system, or electronic or other physical system are representative of the biological effects of the measured LET spectrum. For example, in at least some embodiments, such a final particle field LET spectrum may be within an order of magnitude, plus or minus, for each measured LET energy. The selected data sets are then scaled to fit the measured LET spectrum, block 610. A regression analysis to determine the best fit to the measured let may determine the contribution of each layer and a scale factor for each of the layers. The scale factor for the ith layer, s(i), determines the area of the scoring plane asp(i) for the ith layer: asp(i)=ASP×s(i) where ASP is the is the area of the primary beam at the front surface of the moderator bock normal to the direction of the beam. For example FIG. 2, the asp of the length 203 (e.g. 20 cm) may be about 0.70615 cm², and the asp of the length 205 (e.g. 30 cm) may be area of annular region 212, about 141.2304 cm² and the asp of the length 207 (e.g. 40 cm) of moderator block 200 may be the area of annular region 214, about 549.92176 cm². In block 612, the longest length in the set at block 610 determines the length of the moderator block. Stated otherwise, the length of the moderator block is determined corresponding to the longest length in the data sets in block 610. In block 614, the moderator block is fabricated. The moderator block may be fabricated by boring out cuts or voids from the scoring plane into the material. The length L(i), of each bore is determined such that the remaining material equals the desired length of each layer as determined at block 610. The width of each bore is determined by the corresponding asp(i) as seen in the example at block 610. In block 616, radiological measurements are performed using the final particle field from the fabricated moderator block. Method 600 ends at block 618.

References to “one embodiment”, “an embodiment”, “a particular embodiment”, “example embodiments”, “some embodiments”, and the like, indicate that a particular element or characteristic is included in at least one embodiment of the invention. Although the phrases “in one embodiment”, “an embodiment”, “a particular embodiment”, “example embodiments, “some embodiments”, and the like, may appear in various places, these do not necessarily refer to the same embodiment

The above discussion is meant to be illustrative of the principles and various embodiments of the present invention. Numerous variations and modifications will become apparent to those skilled in the art once the above disclosure is fully appreciated. For example, various other low-Z materials and metamaterials may be used. It is intended that the following claims be interpreted to embrace all such variations and modification.

What is claimed is:

1. A moderator block comprising:
one or more layers of a hydrogen-rich material; and
a plurality of voids disposed in the one or more hydrogen-rich layers, the plurality of voids configured to generate a final particle field such that a linear energy transfer (LET) spectrum of the final particle field corresponds to a measured LET.
